(19) United States
(12) Patent Application Publication
(10) Pub. No.: US 2009/0205453 A1
(43) Pub. Date: Aug. 20, 2009

(54) RING GEAR AND MANUFACTURING METHOD FOR SUCH A RING GEAR

(76) Inventor: Bamidele O. Oyekanmi, Southfield, MI (US)

Correspondence Address: CARGILL & ASSOCIATES, P.L.L.C., 56 MACOMB PLACE, MT. CLEMENS, MI, 48043, US

(21) Appl. No.: 10/597,495

(22) PCT Filed: Jan. 31, 2005
(86) PCT No.: PCT/US05/02625

§ 371 Date: May 7, 2009

(30) Foreign Application Priority Data
Jan. 30, 2004 (US) 10769740

(51) Int. Cl. F16H 55/17; B23P 15/14

(52) U.S. Cl. 74/434; 29/893.36

(57) ABSTRACT

A method of manufacturing a forged article (10) including a surface (18). The method includes defining a negative tooling pattern (52) based on the surface and providing a tooling set (28) having an anvil (30) and top (36) and bottom die (34). An upper surface (40) of the bottom die conforms to the negative tooling pattern. When the tooling is assembled the anvil extends through the bottom die and defines an axis. Additionally, the bottom and top dies cooperate to define a die cavity (76). A hollow blank (38) is preheated and placed on an anvil and into the die. In a single stroke, the hollow blank is pressed between the top and bottom dies in a pressing direction that is parallel to the axis. The preheating temperature Tw is a function of the homologous temperature ratio Tw/Tm is between 0.62 and 0.80, where Tm is the absolute melting temperature of the alloy.

### CROSS-REFERENCE TO RELATED APPLICATIONS

This application is a continuation-in-part of U.S. application Ser. No. 10/769,740 filed Jun. 30, 2004.

### BACKGROUND OF THE INVENTION

1. Field of the Invention

The present invention relates to a method of manufacturing a ring gear and more particularly to a method of manufacturing a ring gear from a billet.

2. Background Art

Traditionally, automotive ring gears have been manufactured by press forging solid blanks at temperatures, approaching 2200° F. Immediately after the pressing operation the “as forged” ring gear blanks enjoy significantly improved mechanical properties over that of the solid blanks. However, because of the exacting tolerances generally required of such ring gears, the as forged ring gear blanks must be machined to their final, or net, shape. The forging process, though, hardens the material to such an extent that machining the ring gear is economically impractical. Accordingly, the ring gear blanks are typically annealed after forging and then machined. Thus, the traditional method of manufacturing ring gears cannot take full advantage of the superior “as forged” properties. Moreover, because annealing requires the application of heat to the ring gear for a period of time, annealing consumes energy. Additionally, the annealing and machining processes consume time and other manufacturing resources. To obtain the needed, surface finish hardness the gear teeth must be induction hardened or the gear carborized.

Additionally, because some ring gears often rotate about a shaft (as opposed to being rigidly attached to a differential casing for example) the finished ring gear requires a central aperture through which the shaft fits. Thus, provisions must be made during the manufacture of the ring gear for the central aperture. For instance, a separate mandrel, or punch, may be employed to create the aperture through the solid blank or the ring gear. However, the separate actions required to form the aperture give rise to an offset between the center of the aperture and the center of the pitch diameter of the ring gear. If placed in service in this condition, the ring gear would tend to vibrate as it rotates, causing deleterious wear e.g., on the teeth of the ring gear, the shaft, the shaft bearings, and the overall machine. Consequently, it is frequently necessary to machine the aperture to eliminate or minimize the offset between the center of the aperture and the center of the pitch diameter of the ring gear.

### SUMMARY OF THE INVENTION

The present invention provides a method of manufacturing forged article including a contoured surface. The method includes defining a negative tooling pattern based on the contoured surface and providing a tooling set having an anvil and a top and bottom die. An upper surface of the bottom die conforms to. the negative tooling pattern. When the tooling is assembled the anvil extends through the bottom die and defines an axis. Additionally, the bottom and top dies cooperate to define a die cavity. A hollow blank is placed on an anvil and into the die. In a single stroke, the hollow blank is pressed between the top. and bottom dies in a pressing direction that is parallel to the axis. During the pressing, the blank initially flows in the pressing direction to form the surface of the article. Thereafter, the blank flows in a direction perpendicular to the pressing direction to fill the die cavity.

In another embodiment, the present invention provides a method of manufacturing a ring gear including a surface having teeth. The method includes defining a negative tooling pattern based on the gear surface and providing a tooling set having an anvil and a top and bottom die. An upper surface of the bottom die conforms to the negative tooling pattern. When the tooling is assembled the anvil extends through the bottom die and defines an axis. Additionally, the bottom and top dies cooperate to define a die cavity. A hollow blank is placed on an anvil and into the die. In a single stroke, the hollow blank is pressed between the top and bottom dies in a pressing direction that is parallel to the axis. During the pressing, the blank initially flows in the pressing direction to form the surface of the ring gear. Thereafter, the blank flows in a direction perpendicular to the pressing direction to fill the die cavity.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an exemplary ring gear constructed in accordance with the teachings of the present invention;

FIG. 1A is a cross sectional view of the exemplary ring gear of FIG. 1;

FIG. 2 is a cross sectional view of an exemplary tooling set for fabricating the ring gear of FIG. 1, the tooling set being constructed in accordance with the teachings of the present invention;

FIG. 3 is a perspective view of an anvil of the tooling set of FIG. 2;

FIG. 4 is partial cross sectional view of a sleeve of the tooling set of FIG. 2;

FIG. 5 is partial cross sectional view of a bottom die of the tooling set of FIG. 2;

FIG. 6 is partial cross sectional view of a top die of the tooling set of FIG. 2;

FIG. 7 is perspective view of an exemplary tubular billet and ring shaped blank for use in fabricating the ring gear of FIG. 1;

FIG. 8 is a cross sectional view of an alternative embodiment of a tooling set;

FIG. 9 is a plot illustrating press load as a function of the stroke of the press for a ring gear formed in conformance with the methodology of the present invention; and

FIG. 10 is a schematic elevation view of a press for use with a tooling to practice the invention.

### DETAILED DESCRIPTION OF THE PREFERRED EMBODIMENT(S)

The following description of the preferred embodiment(s) merely exemplary in nature and is in no way intended to limit the invention, its application, or uses. While the invention is herein described with reference to an exemplary ring gear, the invention should not be construed to be so limited.

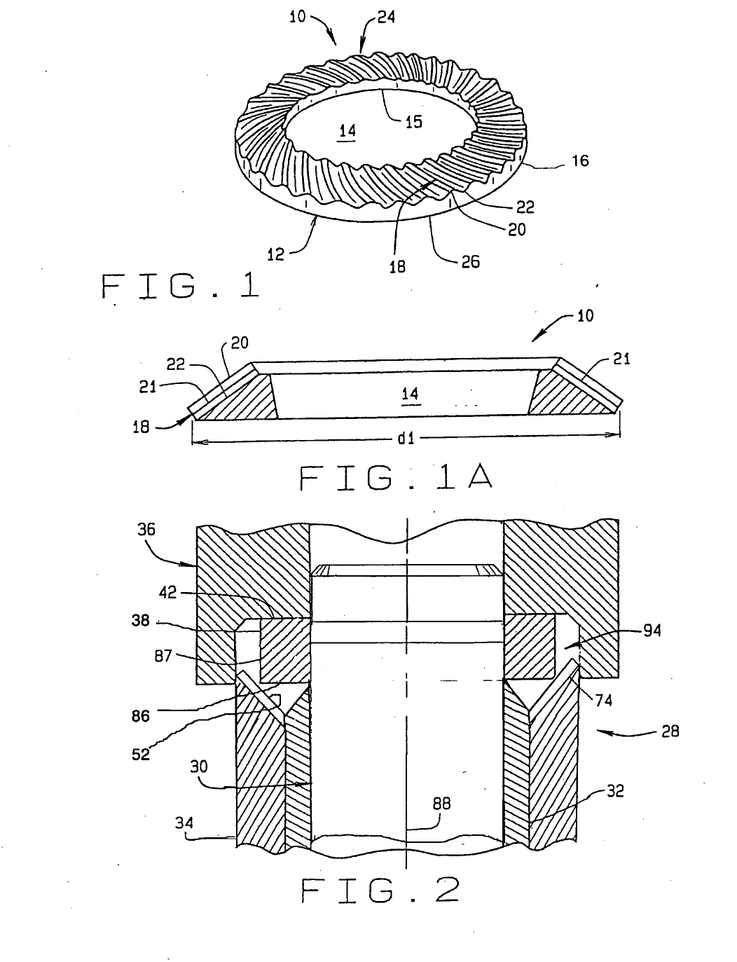

With reference to FIGS. 1 and 1A, an exemplary ring gear that has been formed in accordance with the principles of the present invention is generally indicated by reference numeral 10. The ring gear 10 includes a generally ring shaped body 12 that defines a central aperture 14 with an inner wall 15, an outer (or circumferential) surface 16, and a plurality of teeth 18 that cooperate to define a pitch diameter dl. Each of the teeth 18 includes a top land 20, and a root 22. Also, for purposes of the discussion herein, the ring gear 10 can be said to have a toothed surface 24, whereon the teeth 18 are located, and an opposite surface 26 that is opposite the toothed surface 24.

In FIG. 2, an exemplary tooling set 28 constructed in accordance with the teachings of the present invention and suitable for manufacturing the ring gear 10 is shown. The tooling set 28 may include an anvil 30, a sleeve 32, a bottom die 34, and a top die 36. The material for any of the components of the tooling set 28 may be selected based upon various criteria, including resistance to elevated temperatures, hardness, and wear resistance, for example. In the particular example provided, each of the components of the tool set 28 is formed of CPM® 1 V® alloy, which is commercially available from Crucible Compaction Metals of Oakdale, Pa. Also shown is a hollow or ring shaped, blank 38 that is formed of a material that has been selected for the end application (e.g. the service expected for the forged article). Other considerations for choosing the material of the blank 38 include formability and post forming treatment requirements such as carborization or induction hardening to meet specific case depth and hardness values.

Briefly, to form the ring gear 10, the sleeve 32 is placed over the anvil 30 with the bottom die 34 being centered over the sleeve 32 and the anvil 30. The ring shaped blank 38 is then centered over the anvil 30 so that it rests on an upper surface 40 of the bottom die 34. The top die 36 is then centered over the anvil 30 so that it rests on a top 42 of the ring shaped blank 38 as illustrated. Next, force is applied to the top die 36 to force it down against the ring shaped blank 38. As the force applied increases, the material of the ring shaped blank 38 yields initially flowing down to fill the voids between the blank 38 and the upper surface 40 of the bottom die 34. Thereafter, the material flows radially outward, or laterally, to fill the void between the blank 38 and the top die 36. When the material of the blank 38 has filled the voids between the blank 38 and the top die 36, the force is removed and the ring shaped gear 10 has been formed.

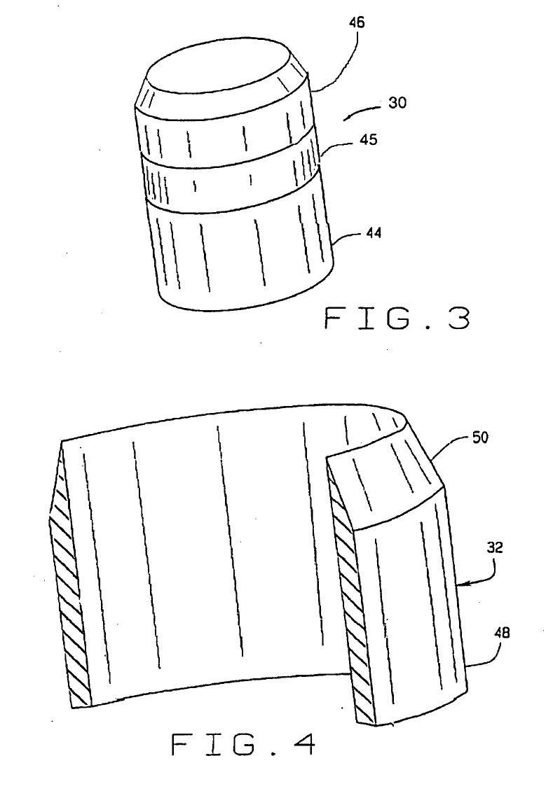

In FIG. 3, the anvil 30 may include a base section 44 at one end and a piloting section 46 at the other end. The sections 44 and 46 may be formed so as to have a constant diameter along its length. A tappered section 45 intermediate the base and pilot sections 44 and 46 may be tapered, for example by about 3 degrees, to ease the ejection of the forged article from the tool set 28. As those of ordinary skill in the art will appreciate from this disclosure, the outer diameter of the pilot section of anvil 30 and sleeve 32 (depending on the axial location) will form the inner diameter of the forged article while the flat transition section forms a counter bore of the forged article. Thus, the material of the article and that of the anvil and sleeve may be chosen to minimize, or eliminate, differences in the thermal coefficients of expansion to thereby minimize flash formation at the point of contact between the anvil and the forged article.

In FIG. 4, the sleeve 32 may include a cylindrical section 48 and a piloting section 50. The cylindrical section 48 may be employed to align the anvil 30 and sleeve 32 while the piloting section 50 may be employed to form a chamfer on the inner diameter of the forged article. While a pilot 50 has been illustrated for forming a chamfer, those of ordinary skill in the art will appreciate that other geometries may be employed. For example, a ridge could be employed on anvil 30 to form a counter-bore in the ring gear or the geometric feature (e.g., the taper 50) may be omitted altogether.

In FIG. 5, the bottom die 34 may include an upper surface 40 that is defined by a negative tooling pattern 52. The negative tooling pattern 52 reflects the desired shape of the toothed surface 24 (FIG. 1) including apexes 54 and troughs 56 which correspond to the roots 22, top lands 20, and other features of the teeth 18 (FIGS. 1 and 1A), respectively. It will be understood those skilled in the art that the finished shape of the toothed surface 24 and the negative tooling pattern 52 may differ to a certain extent. The deviation of the negative tooling pattern 52 from the shape of the toothed surface 24, if employed, may counteract, or offset, various phenomena (e.g., thermal expansion and contraction, shrink, spring back of the blank material, and the like) that are characteristic of the material from which the ring gear 10 is formed. Otherwise, the negative tooling pattern 52 generally reflects the shape of the toothed surface 24 including the gear teeth 18.

The bottom die 34 may also include a body 58 that defines central aperture 60. In the example provided, the central aperture 60 facilitates the centering of the bottom die 34 relative to the sleeve 32. During the pressing operation, the body 58 serves to support the negative tooling pattern 52 rigidly against the blank 38.

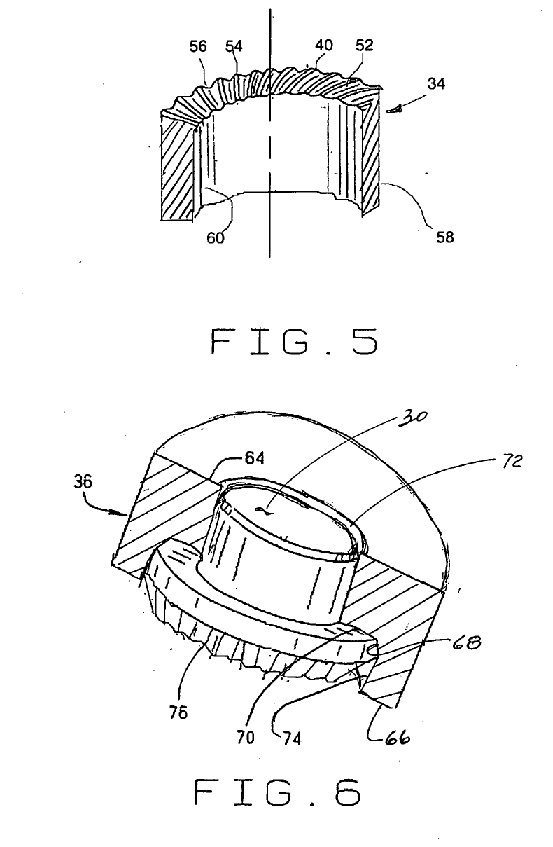

In FIG. 6, the top die 36 may include a first body portion 64, which may define a pressing surface 70, a second body portion 66, which extends downwardly from the first body portion 64, and a central aperture 72. The second body portion 66 may include a transition portion 68 that intersects the cylindrical inner surface 74 of the second body portion 66 and the pressing surface 70. In the particular example provided, the transition portion 68 is conically shaped, but those of ordinary skill in the art will appreciate that other geometrical shapes may be employed in the alternative. Depending on the configuration of the article that is to be forged, the inner surface 74 may be configured such that it slopes radially outward slightly as it descends downwardly to the end of the top die 36 opposite the first body portion 64. While a taper has been shown, other articles may be forged for which the inner surface descends essentially vertically. Again, the features of the tool set 28 depend on the requirements of the article to be forged. The surface 74 may blend into the transition portion 68 that, in turn, may merge into the pressing surface 70. Together-the surface 74, the transition portion 68, the pressing surface 70, and the negative tooling pattern 52 define a die cavity 76 the slope of the ring gear to be formed. The first body portion 64 also defines a central aperture 72 for centering the top die 36 over the anvil 30.

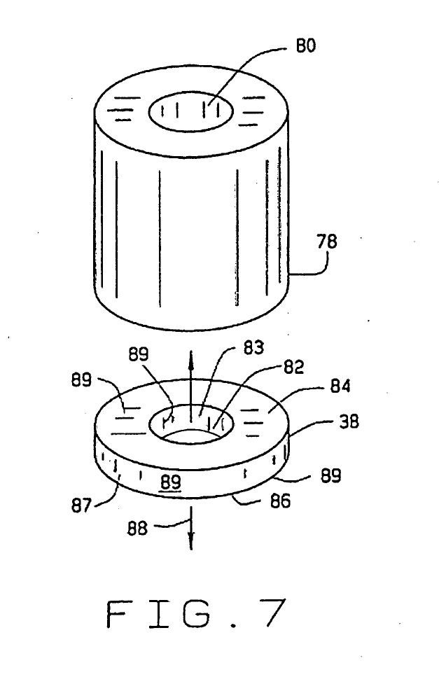

As shown in FIG. 7, a hollow, or tubular, billet 78 may be sectioned to create one or more of the ring shaped blanks 38. It should be noted that the tubular billet 78 is generally cylindrical with a central aperture 80 that corresponds to a central aperture 82 in the ring shaped blank 38. The billet 78 may have an inner diameter that fits over the outer diameter of the anvil 30 and an outer diameter that fits into the die cavity. Alternatively, the inner diameter and/or outer diameter of the billet 78 (or the blank 38) may be machined to desired size.

After being sectioned from the tubular billet 78, the ring shaped blank 38 has a first end surface 42, a second end surface 86, and a circumferential surface 87. Additionally, the ring shaped billet defines a central axis 88 in the direction between the end surfaces 42, 86. In the example provided, the central axis 88 is generally perpendicular to the end surfaces 42, 86 and coincident to the axis of the central aperture 82. Those skilled in the art will appreciate from this disclosure, however, that the central axis 88 is a reference axis and may be oriented differently with respect to one or more of the end surfaces 82, 42 and the central aperture 82 as desired. Additionally, an inner wall 83 of the blank 38 defines the central aperture 82.

If desired, the blank 38 may be treated in a secondary operation to alter the characteristics of the blank 38 prior to forging and/or to improve the characteristics of the forged article. For example, the blank 38 may be annealed. Preferably the blank is processed through a shot blasting operation to reduce or eliminate residual stress and/or provide surfaces of the blank 38 with a desired surface finish. Preferably a coating 89 is applied to one or more of the surfaces 82, 42, and/or 87 of the ring shaped blank 38. The coating 89 forms a lubricant suitable for use at forging temperatures, such as a graphite-based lubricant, to provide lubricity between the surfaces of the blank 38 and corresponding surfaces of the tool set 28 during the pressing operation.

Returning to FIG. 2, the tooling set 28 is shown in an operative manner in conjunction with the blank 38. As illustrated, the section 44 of the anvil 30 extends through the sleeve 32 and the bottom die 34, thereby aligning the centers of these components of the tool set 28. Moreover, the piloting section 46 of the anvil 30 extends from the bottom die 34 to engage the inner diameter of the blank 38 and the top die 36. Thus, the anvil 30 may also align the blank 38 and the top die 36.

FIG. 2 also illustrates the blank 38 as it is situated in the die cavity 76 that is formed by the bottom and top dies 34 and 36. In particular, the inner diameter of the blank 38 engages the outer diameter of the anvil 30. The circumferential surface 87 (FIG. 7) of the blank is spaced apart from the inner surface 74 of the top die 36. During the pressing operation (as discussed herein), the blank 38 will flow laterally at one point in the forming operation to fill the void between the circumferential surface 87 and the inner surface 74. Moreover, the blank 38 is shown centered over the bottom die 34 and resting on the apexes 54 of the negative tooling pattern 52. Accordingly, when the ring gear 10 is formed, the features of the ring gear 10 will be accurately located with respect to a central axis 90 of the ring gear that generally corresponds with the central axis 88 of the ring shaped blank. Thus, the ring gear 10 will be formed in a concentric manner.

Moreover, the ring shaped blank 38 is shown, in FIG. 2, to be positioned on the bottom die 34 such that one of its end surfaces, for example, end surface 86 is proximate the negative tooling pattern 52. Thus, when the blank 38 is pressed, the end surface that is proximate the negative tooling pattern 52 (i.e., end surface 86 in the example provided) will form the front 24 the ring gear 10. Those skilled in the art will appreciate from this disclosure that in some situations, it may not be necessary to orient the blank 38 in the die cavity 76 in any particular manner and as such, the blank 38 may be flipped so that either of the end surfaces 42, 86 may be positioned proximate the negative tooling pattern 52.

In some circumstances, for example where the end surfaces 42, 86 are not generally parallel one another, there may be a need to orient the blank 38 into the die cavity 76 in a predetermined manner. Similarly, the other end surface of the ring shaped blank 38 (i.e., end surface 42 in the example provided) will form the back 26 of the ring gear 10. Also, a plurality of teeth voids 92 may be seen defined between the negative tooling pattern 52 and the bottom 86 of the ring shaped blank 38. Similarly, an annular void 94 may be seen defined between the circumferential surface 87 of the ring shaped blank 38 and the inner surface 74 (with the arc 68, the pressing surface 70, and the bottom die 34 completing the definition of the annular void 94).

In operation, the tubular billet 78 is sectioned to form the ring shaped blank 38. In the particular example provided, a 1.5-inch section of a 5.0 inch inner diameter by 8.0 inch outer diameter steel tube forms the ring shaped blank 38. It should be noted that the die cavity 76 of the top die 36 is designed so that when the ring shape blank 38 has been pressed-to the desired thickness the resulting ring gear just fills the die cavity 76 around the anvil 30 (except, of course, for the portion of the die cavity 76 accounted for by the stroke of the top die). In the particular example provided the die cavity 76 is designed to accommodate a 11 pound ring gear 10 conventionally made from an 18 pound solid billet.

After sectioning, the blank 38 in this example was shot blasted and a lubricant coating 89 was applied to the ring shaped blank 38 to reduce friction between the blank and the tool set 28 during the pressing operation. Preferably the blank is preheated to about 300° F.±35° F. prior to applying the lubricant coating.

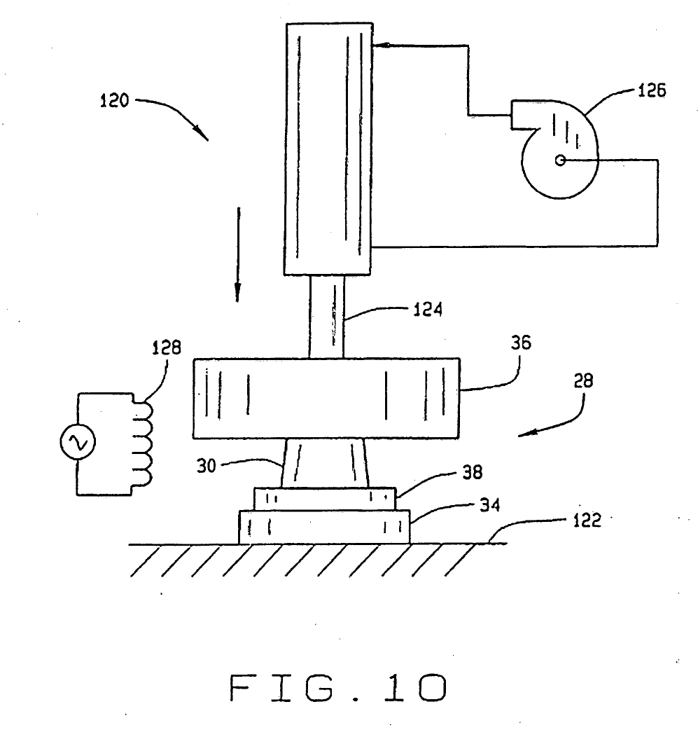

With reference now to FIG. 10, a press 120 is prepared for pressing the blank 38. The press 120 including a platen 122, a ram 124, a hydraulic system 126, and an induction heater 128 for use with the exemplary tooling set 28. The bottom die 34 may be placed over the anvil 30 and bolted to (or otherwise rigidly attached to) the platen 122. The ring shaped blank 38 may be positioned over the anvil 30 and brought down against the bottom die 34. The top die 36 may be positioned over and in close proximity to the blank 38.

The induction heater 128 may be employed to heat the blank 38 to a predetermined forging temperature prior to the forming of the blank 38. In the example provided, the predetermined forging temperature may be about 1700 degrees Fahrenheit to about 1800 degrees Fahrenheit. In addition, the anvil 30, sleeve 32, and the dies 34 and 36 may be heated in press 120 by a gas fire or an induction heater to about 300° F before the forging operation.

Preferably the forging temperature is determined based upon the properties of the alloy blank used. Preferably the forging temperature will vary as a function of the absolute melting temperature. The forging or working temperature Tw divided by the melting temperature of the alloy Tm, expressed relative to absolute zero forms a homologous temperature ratio. (Tw/Tm) Preferably the homologous temperature ratio is in the range of 0.62 to 0.80. More preferably the homologous temperature ration is in the range of 0.65 to 0.70. Forging temperatures having a homologous temperature ratios which are too low result in a work hardening of the forged material, minimal recrystallization and increased peak forging load. Too high of a forging temperature may result in excessive grain growth and part scaling. For most alloys a homologous temperature ratio of about 0.65 results in a working temperature yielding satisfactory parts. One of ordinary skill in the art will appreciate that the operating temperature may be experimentally determined from the 0.65 starting point in order to optimize a performance of the particular alloy and part being formed.

The pressing stroke is initiated wherein the ram 124 moves toward the platen 122 so that the top die 36 is translated toward the bottom die 34 via hydraulic pressure that is supplied by the hydraulic system 126. The pressure on the blank 38 builds rapidly beyond the yield point of the blank 38 causing the material that forms the blank to flow in an axial direction generally parallel to the pressing stroke into the teeth voids 92.

When the bottom of the blank 38 conforms to the top of the negative tooling pattern 52 that was originally directly under the blank 38, the axial flow of the material that forms the blank 38 stops and flows instead in a radial direction that is generally perpendicular to the pressing stroke. Any voids that may have existed between the anvil 30 and the blank 38 (e.g., due to run out or differences in concentricity), the material that forms the blank 38 flows laterally inward to fill the void. The material that forms the blank 38 will also flow radially outward, thereby filling the annular void 94.

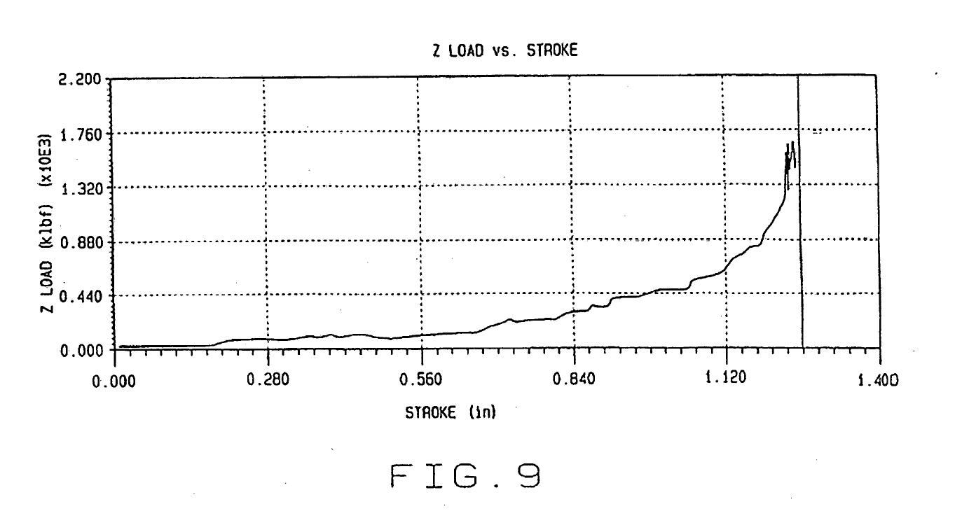

The pressing stroke is adjusted so that the upper die travel stops when the radial flow (that follows the axial flow) has been halted and the blank material fills the die cavity. If the blank 38 included excess material, it will appear on the back 26 of the ring gear 10. Excess material results in increased peak press load resulting from deflection of the press and tooling when the die cavity fully packs out. The shape of the load as stroke curve is shown in FIG. 9 for a typical automotive ring gear. Thus to minimize excess material on the ring gear 10, the blank 38 may be volumetrically controlled (i.e., one or more of the height, outer diameter and inner diameter may be machined as necessary to put the blanks 38 in a condition wherein they are of a predetermined volume) or the blank 38 may be controlled by weight (i.e., one or more of the height, outer diameter and inner diameter may be machined as necessary to put the blanks 38 in a condition wherein they are of a predetermined weight).

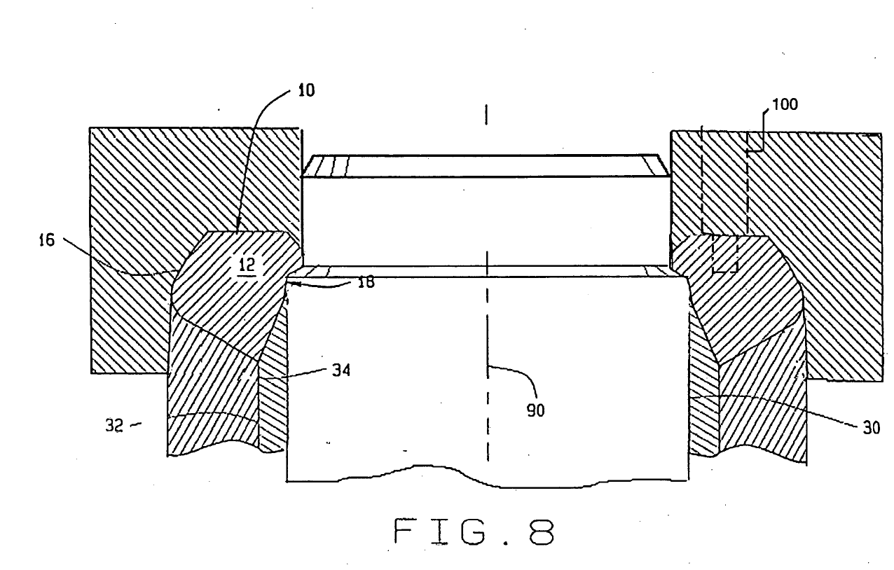

FIG. 8 illustrates the net formed ring gear 10 still in the die 36 and anvil 30. It should be noted that during forging, the material of the blank 38 may be dynamically re-crystallized. In the particular example provided, the grain size of the material from which the gear 10 is made has a re-crystallized grain size of about 7 to about 8 ASTM grain size.

When the ram 124 returns the top die 36 to a condition that is elevated above the lower die 34, the anvil 30 ejects the net formed ring gear 10 from the bottom die 34. Importantly, the ring gear 10 is concentric and the teeth 18 have been net formed (as shown in FIG. 8). Thus, the as forged ring gear 10 requires little, if any final machining. Moreover, any excess material of the blank 38 will be found at the back 26 of the ring gear 10 where it may be easily removed. Accordingly, the prior art of annealing and machining steps may be reduced, or eliminated with significant cost savings accrued accordingly. A series of holes for mounting a ring gear to a differential carrier are typically formed on the rear surface 42 of the ring gear after the forging operation. In order to minimize the machining time and the resulting scrap the upper die 36 may be provided with an array of die pins 100 illustrated in phantom outline in FIG. 8 for forming an array of blind holes in the ring gear. These holes can be subsequently tapped so that the ring gear may receive threaded fasteners used to mount the ring gear to the differential carrier.

Ideally they will be minimal post forging machining required if the blank weight is within tolerance and little or no machining to the rear surface of the ring gear is required other than tapping the mounting holes. The gear teeth ideally are near net shape and simply require a final lapping in order to obtain the desired gear surface finish. To obtain the desired gear tooth hardness, it may be necessary to induction hardened the gear teeth (alternatively the ring gear may be carborized) prior to lapping.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of manufacturing a forged article including a surface, the method comprising:
defining a negative tooling pattern based on the surface;
providing a tooling set having a bottom die, a top die and an anvil, the bottom die being formed with an upper die surface that conforms to the negative tooling pattern, the anvil extending through the bottom die and defining an axis, the bottom die and the top die cooperating to define a die cavity;
preheating an annular blank formed of ferrous material to forging temperature selected Tw release to the melting temperature Tm of the material so that the homologous absolute temperature ratioTw/Tm is between 0.62 and 0.80;
placing an annular blank on an anvil and into the die cavity between a top die and the bottom die; and
pressing the blank between the top and bottom dies in a pressing direction that is generally parallel to the axis to form the forged article in single stroke.

2. The method according to claim 1, wherein homologous temperature ratio is 0.65 to 0.70.

3. The method according to claim 2, wherein the hollow blank is heated to a temperature of about 1700 degrees Fahrenheit to about 1800 degrees Fahrenheit.

4. The method according to claim 1, further comprising selecting a forging temperature so that the material dynamically re-crystallizes to an ASTM grain size of about 7 to about 8 as the blank is being forged.

5. The method according to claim 1, further comprising coating the hollow blank with a lubricant prior to forging.

6. The method according to claim 1, wherein the forged article is net shaped or near-net shaped.

7. The method according to claim 1, further comprising forming the hollow blank such that it conforms to a predetermined volumetric size to thereby control a weight of the forged article.

8. The method according to claim 1, further comprising sectioning a tube shaped billet to create the hollow blank.

9. The method according to claim 1, further comprising removing an amount of excess material from a second surface of the forged article opposite the surface.

10. The method according to claim 1, wherein the hollow blank is ring-shaped.

11. A forged article made according to the method of claim 1.

12. A method of manufacturing a ring gear including a surface having teeth, the method comprising:
defining a negative tooling pattern based on the surface;
providing a tooling set having a bottom die, a top die and an anvil, the bottom die being formed with an upper die surface that conforms to the negative tooling pattern, the anvil extending through the bottom die and defining an axis, the bottom die and the top die cooperating to define a die cavity;
preheating an annular blank formed of ferrous material to forging temperature selected Tw release to the melting temperature Tm of the material so that the homologous absolute temperature ratioTw/Tm is between 0.62 and 0.80;
placing an annular blank on an anvil and into the die cavity between a top die and the bottom die; and
pressing the blank. between the top and bottom dies in a pressing direction that is generally parallel to the axis to form the ring gear.

13. The method according to claim 12, wherein homologous temperature ratio is 0.65 to 0.70.

14. The method according to claim 13, wherein the hollow blank is heated to a temperature of about 1700 degrees Fahrenheit to about 1800 degrees Fahrenheit.

15. The method according to claim 12, further comprising dynamically re-crystallizing a material of the hollow blank to an ASTM grain size of about 7 to about 8 as the hollow blank is being pressed.

16. The method according to claim 12, further comprising coating the hollow blank with a lubricant.

17. The method according to claim 12, wherein the ring gear is net shaped or near-net shaped.

18. The method according to claim 12, further comprising forming the hollow blank such that it conforms to a predetermined volumetric size to thereby control a weight of the ring gear.

19. The method according to claim 12, further comprising forming during the forging pressing operation a series of fluid holes.

20. A ring gear made according to the method of claim 12.
